(19) United States
(12) Patent Application Publication
(10) Pub. No.: US 2007/0214201 A1
(43) Pub. Date: Sep. 13, 2007

(54) Units conversion using flexible, parseable syntax

(76) Inventor: Anthony Alexander Renshaw, New York, NY (US)

Correspondence Address: Anthony A. Renshaw, PO Box 20327, New York, NY, 10021, US

(21) Appl. No.: 11/716,764

(22) Filed: Mar. 12, 2007

Related U.S. Application Data
(60) Provisional application No. 60/781,937, filed on Mar. 13, 2006.

(51) Int. Cl. G06F 7/00

(52) U.S. Cl. 708/204

(57) ABSTRACT

The present invention relates to tools for converting dimensional, numerical values from one set of units to another quickly and efficiently. More particularly, it relates to improved, computer-based systems, methods and software for changing between different units and for converting to and from a pre-specified standard set of units. The current embodiments accomplish these changes with as much simplicity, as flexible a syntax, and with as little chance of human error as possible.

The present application claims the benefit of U.S. Provisional Application Ser. No. 60/781,937 filed Mar. 13, 2006 which is incorporated by reference herein in its entirety.

### FIELD OF INVENTION

The present invention relates to tools for converting numerical values from one set of units to another quickly and efficiently. More particularly, it relates to improved, computer-based systems, methods and software for changing numerical values between different units and for converting to and from a pre-specified standard set of units. The current embodiments accomplish these changes with as much simplicity and with as little chance of human error as possible. In addition, the syntax with which different units can be expressed is flexible enough to correctly accommodate many alterative expressions of the same set of units. This allows users of the invention to use units expressed in to their own personal preferences.

### BACKGROUND OF THE INVENTION

In numerous human endeavors and quantitative fields, there is a need to quickly, efficiently, and accurately convert input numerical values from one set of units to another. For example, as the global economy expands, there is a pressing need to be able to convert from the United States Customary System of Units (inches, pounds, etc.) to equivalent metric units such as meters, kilograms and Newtons.

There are existing tools and methods for assisting people in this conversion. For example, many engineering textbooks contain tables with lists of conversion factors. These are often displayed on the inside of the book's covers for handy reference. There are also resource references that contain conversion factors and procedures for a wide range of different fields. For example, the CRC Handbooks and Desk Reference series covers fields as diverse as chemistry, physics, engineering and nutrition.

Computer-based tools have also been developed. For example, websites give tools in which the user can choose various pre-programmed units from a pull down menu in order to convert from one unit to another. Within Microsoft Excel, there is a software function called “Convert” that will convert from some units to others.

Despite these resources and tools, unit conversion is still often a time consuming and error-prone process. For example, many introductory undergraduate engineering textbooks give numerical problems that are substantially exercises in changing from one unit to another. See, for example, J. A. Wickert, An Introduction to Mechanical Engineering (First Edition), Brooks/Cole—Thomson Learning, 2004, which is incorporated by reference herein in its entirety. While the time and effort expended on such exercises can be valuable for familiarizing students with different kinds of units, the actual process of conversion is dreary and uninteresting.

Consequently, there is a need for alternative tools that enable students and professionals to quickly, efficiently, and correctly convert numerical quantities from one set of units to another.

There is also a need for tools that are flexible enough to interpret many of the commonly found variations for expressing units. For example, the dimensional, numerical value “12 inches” could be expressed as “12 inches”, “12 inch”, or “12 in”. It could also be expressed as “1 foot” or “1 ft”. When engineers and scientists are working with dimensional, numerical values, they often have strong preferences for how they would like to express dimensional numerical values. While all of the above expressions are equivalent, none are superior to the others except in particular situations for a particular user. For example, if an experiment involves measuring length with a ruler that only indicates inches, then inches would be a preferred input unit. Tools that allow the user to convert dimensional numerical values in the units and with the syntax that they prefer are needed.

There is also a need for tools that enable a formula to be set up or programmed on a computer-based method or system that will automatically produce the correct numerical result for the formula given input parameters in any possible set of consistent input units. Such a computer-based method or system would help prevent costly unit conversion errors.

A convenient platform for such computer based tools is an add-in for Microsoft Excel. Microsoft Excel provides an easy to use environment for numerical archiving and problem solving. Add-ins provide an easy method for adding functionality to that environment.

There are numerous units conversion tools currently on the internet. For example, one site has the internet address http://www.onlineconversion.com. While these sites can accurately convert units, they are limited to the units that they have in their drop down menus. For example, on the acceleration conversion page of this site (http://www.onlineconversion.com/acceleration.htm), there is a list of available accelerations that can be interpreted. This list includes the following twenty-one possible units: centigal, centimeter/square second, decigal, decimeter/square second, dekameter/square second, foot/square second, g-unit (G), gal, galileo, gn, grav, hectometer/square second, inch/square second, kilometer/hour second, kilometer/square second, meter/share second, mile/hour minute, mile/hour second, mile/square second, milligal, and millimeter/square second. If this list includes the units that are needed, this tool works. If a unit is needed that is not on this list, say, for example, feet/square minute, then this tool does not work.

Octavian Micro Development Inc. (see www.octavian.com/excel.html) provides a unit conversion tool in the form of an Excel add-in. Unfortunately, this tool suffers a number of disadvantages. The syntax chosen is cumbersome in that all compound units must be separated by the multiplication character ‘*’. The division symbol, ‘/’, is not recognized. As a result, the input symbols are significantly different than customarily encountered. For example, rather than expressing velocity as “m/s”, one must type “m*ŝ−1”. This is significantly more typing and much more difficult to read and interpret. Furthermore, this tool does not have a separate unit to represent a relative difference in temperature. Taken together, these are major limitations.

Apricot Software (see http://www.unit-conversion.com/) sells a unit conversion tool in three different forms: WinUnit (a stand alone program), an Excel add-in, and a COM Server application. The syntax allowed by this software is more flexible than that developed by Octavian Micro Development. For example, both “N.s/m2” and “N.s.m−2” are allowed to express the units of Newton seconds per meter squared. However, the allowable syntax is still highly limited. The expression cannot accept two division signs (“Btu/lb/degF” is not allowed, even though it clearly indicates Btus per pound per degree Fahrenheit); neither the ‘*’ symbol nor the space symbol ‘ ’ can be used to indicate multiplication; the ‘−’ symbol can only be used to indicate negative exponents, not as a separator such as in “kg-m/s”; and only integer exponents are allowed. While most sets of units can be expressed in this tool, the syntax is cumbersome and does not allow the user to use the syntax her or she prefers.

Therefore, there is a need for an easy to use tool that is less cumbersome than existing tools for performing units conversion and for programming quantitative formulas. The tool should use a flexible syntax that allows many commonly used variations of units to be correctly parsed and interpreted.

### SUMMARY OF THE INVENTION

The present invention is a tool for doing units conversion using a flexible, parseable syntax. The tool also allows flexible, parseable units conversion to and from standard metric Meter-Kilogram-Second (MKS) units. The tool is currently available as an Excel add-in (available from www.ChangeUnits.com). This specification describes the syntax, functions, and features of the tool and gives some simple examples. A more complete understanding of the present invention, as well as further features and advantages of the invention, will be apparent from the following Detailed Description and the accompanying drawings.

### BRIEF DESCRIPTION OF THE DRAWINGS

FIG. 1 shows a computer based system which may be suitably utilized to implement the present invention;

### DETAILED DESCRIPTION

The present invention may be suitably implemented as a computer-based system, in computer software which resides on computer readable media, such as solid state storage devices, such as RAM, ROM, or the like, magnetic storage devices such as a hard disk or floppy disk media, optical storage devices, such as CD-ROM or the like, or as methods implemented by such systems and software.

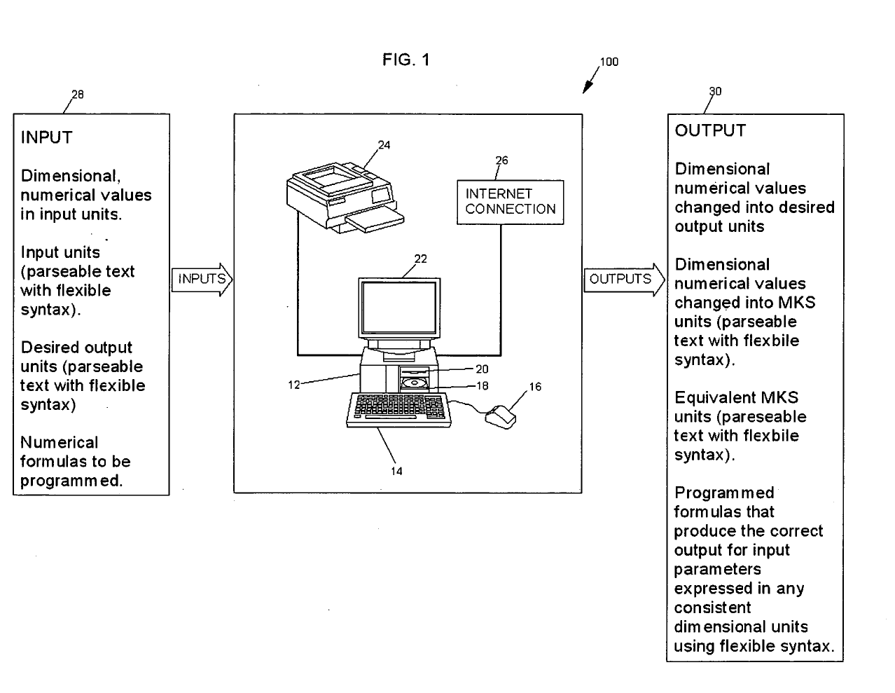

FIG. 1 shows a block diagram of a computer system 100 which may be suitably used to implement the present invention. System 100 is implemented as a computer 12, such as a personal computer, workstation, or server. One likely scenario is that the system of the invention will be implemented as a personal computer or workstation which connects to a server or other computer running software to implement the processes of the present invention either through a network, Internet or other connection. As shown in FIG. 1 and described in further detail below, the system 100 includes software that is run by the central processing unit of the computer 12. The computer 12 may suitably include a number of standard input and output devices, including a keyboard 14, a mouse 16, CD-ROM drive 18, disk drive 20, monitor 22, and printer 24. In addition, the computer 12 may suitably include an Internet or network connection 26 for downloading software, data and updates or for providing outputs to remote system users. It will be appreciated, in light of the present description of the invention, that the present invention may be practiced in any of a number of different computing environments without departing from the spirit of the invention. For example, the system 100 may be implemented in a network configuration with individual workstations connected to a server. Also, other input and output devices may be used, as desired. For example, a remote user could access the server with a desktop computer, a laptop utilizing the Internet or with a wireless handheld device such as a Blackberry™, Treo™, or the like.

One embodiment of the invention has been designed for use on a stand-alone personal computer or workstation with an Intel Xeon, Pentium, or later microprocessor, using as an operating system Microsoft 2000 or XP.

According to one aspect of the invention, it is contemplated that the computer 12 will be operated by a user in an office, classroom, or study setting. However, if desired, it would also be possible to practice the invention with the user using an off-site computer and either loading the below-described software onto the off-site computer or connecting to a server computer running the software.

As illustrated in FIG. 1, and as described in greater detail below, additional inputs 28 may suitably include dimensional numerical values in any desired input units, the corresponding input units expressed as a parseable string of text characters in a flexible syntax, the desired output units also expressed as a parseable string of text characters in a flexible syntax, and numerical formulas to be programmed using a standardized units conversion tool.

As further illustrated in FIG. 1, and as described in greater detail below, the system outputs 30 may suitably include dimensional numerical values changed into desired output units, dimensional numerical values changed into standard MKS (meter-kilogram-second) units, a textual string giving equivalent MKS units of the input units in a flexible syntax, and programmed formulas that produce the correct dimensional, numerical output for input units expressed in any combination of consistent dimensional units. The output information may appear on the monitor 22 or may also be printed out at the printer 24. The output information may also be electronically sent to an intermediary for interpretation. Other devices and techniques may be used to provide outputs, as desired.

With this background in mind, we turn to a detailed discussion of a presently preferred embodiment of the invention and its context.

This invention allows units to be expressed as simple combinations of pre-programmed base units expressed with a flexible syntax. For example, this invention interprets “m/ŝ2”, “m/s/s”, “m Ŝ−2”, “m/s s”, “m/s*s”, and “m/s−s” as equivalent units for acceleration and “slug*m/ŝ2” as a force, even though it combines metric and English units. In these examples, several different characters can be used, at the users discretion, to represent multiplication of pre-programmed based units: ‘ ’, ‘*’, ‘−’, and a second ‘/’. This is a flexible syntax because distinct text characters can be used to indicate base unit multiplication. This invention also changes to and from standard metric MKS units, which is convenient for programming formulas.

Many other unit conversion tools, including Excel's own Convert function (available in the Analysis ToolPak add-in), require multiple calls to convert units not included on its list of known units, increasing the risk of typing errors and incorrect conversion. This invention solves this problem by letting you directly convert any combination of units to any other combination of units in a single step.

This invention parses the input units by converting each separate unit in turn. One of the primary advantages of changing units this way is that only a relatively small number of base units need to be recognized (currently, there are about 180 base units). If, instead of parsing, the invention attempted to recognize all possible combinations of units (as is done on the drop down menus available on some internet, units conversion sites), the number of units that would need to be recognized would be much larger. For example, if there were 10 different length units and 10 different time units, then there would be 100 possible velocity (length/time) units and 1000 possible acceleration (length/timê2) units. Not only would this be tedious to program and maintain, it would require many unnecessary syntax decisions such as whether or not to allow “m/ŝ2” or “m/s/s”. Because the present invention parses and allows a flexible syntax, it recognizes these different syntaxes as equivalent, allowing the user to use the units and syntax that best suits his or her needs and preferences.

As a further example, consider the specific case of units for acceleration. The online site previously describes recognizes a total of twenty-one different sets of units describing acceleration. In the present invention, if we use the list of base units described later in this specification, there are 22 different kinds of lengths and 12 different kinds of time dimensions. Using just these base units, the invention is able to recognize 3168 different kinds of acceleration. This is significantly more than the prior art. In addition, there are additional variations of acceleration that can be formed using base units such as “mph” and the like.

The invention may have the following functions:

### (1) ChangeUnits(Val, InUnits, OutUnits)

Change Val from InUnits to OutUnits.
Input Val=Input value expressed in InUnits (a number)
   InUnits=The units of Val (a text string)
   OutUnits=The units to output (a text string)
Output: Val expressed in OutUnits (a number)

### (2) ToMetric(Val, InUnits)

Change Val from InUnits to standard metric MKS units.
Input Val=Input value expressed in InUnits (a number)
   InUnits=The units of Val (a text string)
Output: Val expressed in MKS units (a number)

### (3) FromMetric(Val, OutUnits)

Change Val from standard metric MKS units to OutUnits.
Input Val=Input value expressed in MKS units (a number)
   OutUnits=The units to output (a text string)
Output: Val expressed in OutUnits (a number)

### (4) ShowMetric(InUnits)

Show the standard metric MKS units equivalent of InUnits.
Input InUnits=Input units (a text string)
Output: Equivalent MKS units of InUnits (a text string)

### (5) ShowCommonMetric(InUnits)

Show the standard metric MKS units equivalent of InUnits except for four common units which are not expressed in base units:
   J=kg m̂2/ŝ2
   N=kg m/ŝ2
   W=kg m̂2/s
   Pa=kg/m/ŝ2
Input InUnits=Input units (a text string)
Output: Equivalent MKS units of InUnits (a text string)

### (6) Grav( )

Output: Returns 9.806652 m/ŝ2, the gravitational constant.

### (7) GasConst( )

Output: Returns 8.31434 J/mol/degK, the universal gas constant.

The simplest use of the invention is to change a dimensional numerical value from one unit to another using the ChangeUnits function. Table 1 below shows an Excel worksheet in which 10 inches has been changed using the ChangeUnits function. Column D has the call to the function: in cell D2, the formula is “=ChangeUnits(A2, B2, E2)”. In cell D3, the formula is “=ChangeUnits(A3, B3, E3)”. And so on.

In cell D2, 10 “inch” changes to 10 “in”, since both “inch” and “in” are interpreted or parsed as inches. In cell D3, 10 “inch” is equal to 0.254 “m”. In cell D4, we have tried to change “inch” into “dollars”. Since “dollars” is unknown to ChangeUnits, the error message returned is “Unknown unit ‘dollars’”. Finally, in cell D5, we have tried to change 10 “inch” into “kg”. Since “inch” and “kg” are not equivalent units, ChangeUnits returns the error message “Inconsistent units”.

TABLE 1
The ChangeUnits function.

| | A | B | C | D | E |
|---|---|---|---|---|---|
| 1 | Value | InUnits | Equals | Output | OutUnits |
| 2 | 10 | inch | = | 10 | in |
| 3 | 10 | inch | = | 0.254 | m |
| 4 | 10 | inch | = | Unknown unit ‘dollars’ | dollars |
| 5 | 10 | inch | = | Inconsistent units | kg |
| 6 | | | | | |

In Table 2 below, we show a number of alternative but equivalent methods for expressing the same units that are recognized by ChangeUnits (“m/ŝ2” in this example). The programming in the cells is the same as in Table 1.

TABLE 2
Alternative Allowable Syntaxes Recognized by the Invention

| | A | B | C | D | E |
|---|---|---|---|---|---|
| 1 | Value | InUnits | Equals | Output | OutUnits |
| 2 | 10 | m/s\hat{ }2 | = | 10 | m/s\hat{ }2 |
| 3 | 10 | m/s s | = | 10 | m/s\hat{ }2 |
| 4 | 10 | m/s − s | = | 10 | m/s\hat{ }2 |
| 5 | 10 | m/s/s | = | 10 | m/s\hat{ }2 |
| 6 | 10 | m\hat{ }1/s\hat{ }2 | = | 10 | m/s\hat{ }2 |

Table 3 below illustrates the ToMetric and FromMetric functions by calculating the area of a rectangle.

The width of the rectangle, b, is given in cell C4 and its units are given in cell D4. In this example, b=1 m. The height of the rectangle, h, is shown in cell C5 and its units are shown in cell D5. In this case, h=2 m.

Although the input units are already in MKS units, we don't assume that this will always be the case. Instead, we change the input units into MKS values in column E. So cell E4 is the function “=ToMetric(C4, D4)”, which gives a value of 1, and cell E5 is “=ToMetric(C5, D5)”, which gives a value of 2.

The formula for the area of a rectangle, A=b*h, is programmed in cell E6 using the values in the MKS column E, namely, E6=E4*E5. For this problem, the area is 2 m̂2.

As output, we list the units we want in cell D6, in this case m̂2. The answer to the problem is given in C6 using the formula C6 “=FromMetric(E6, D6)”.

We show the MKS units used in column F. For example, F4 “=ShowMetric(D4)”.

TABLE 3
Calculating the area of a rectangle in typical units.

| | A | B | C | D | E | F |
|---|---|---|---|---|---|---|
| 1 | Calculate the area of a rectangle | | | | | |
| 2 | | Symbol or | | | MKS | MKS |
| 3 | Description | Formula | Value | Units | Value | Units |
| 4 | Width | b | 1 | m | 1 | m |
| 5 | Height | h | 2 | m | 2 | m |
| 6 | Area | A = b h | 2 | m\hat{ }2 | 2 | m\hat{ }2 |
| 7 | | | | | | |

Now suppose that we want to calculate the area of a rectangle with different inputs. Suppose b=1.0e4 inches, h=2 mm, and we want the answer in milê2. We simply change the cells C4, D4, D5, and D6, and obtain Table 4.

The formula itself (cell E6) did not need to be changed, only the input units and values and the output units. Once a formula has been correctly programmed, the only errors that can occur are typographical errors in the input boxes.

TABLE 4
Area of a rectangle in some unexpected units.

| | A | B | C | D | E | F |
|---|---|---|---|---|---|---|
| 1 | Calculate the area of a rectangle | | | | | |
| 2 | | Symbol or | | | MKS | MKS |
| 3 | Description | Formula | Value | Units | Value | Units |
| 4 | Width | b | 1.00E+04 | in | 254 | m |
| 5 | Height | h | 2 | mm | 0.002 | m |
| 6 | Area | A = bh | 1.96E−07 | mile\hat{ }2 | 0.508 | m\hat{ }2 |
| 7 | | | | | | |

The only disadvantage of doing calculations this way is that the add-in does not know the correct output units of the formula that has been programmed, so it cannot catch when the user asks for inconsistent output units. For example, in Table 4, if one puts “lbm” into cell D6, then cell F6 correctly updates to kg, but the value in cell C6 is 1.119948292, the equivalent of 0.508 kg even though the formula intends that cell E6 be interpreted as length-squared rather than mass.

The invention uses the following syntax rules and conventions:
All units are case and spelling sensitive (to distinguish mJ and MJ, for example)
The only characters that matter are the base units, the first division sign (“/”) encountered, the exponentiation character (“̂”), and numerical exponents (rational and negative exponents are allowed). Everything else is ignored (i.e., treated as white space). So, for example, the following are all interpreted exactly the same:
   m/s/s=m/s−s=m/s s=m/s s=m/ŝ2
Parentheses are always ignored.

A one ‘1’ can be used as a placeholder as in “1/m” or to indicated dimensionless units. An empty cell is treated as a dimensionless unit.

The first division sign, if any, encountered is used to split the text string into two parts, an initial numerator and a final denominator string. This decomposition is central to the units parsing, and enables many alterative combinations of units to be uniquely interpreted. For example, m/s*kg/degC is equivalent to m/(s kg degC); it is not equivalent to m kg/(s degC).

The list of pre-programmed base units only has lbf, lbm, ozf, and ozm to distinguish English mass and force. The units lb and oz are not recognized in order to avoid ambiguous and possibly erroneous conversions.

Derived units with special names are included in the list of pre-programmed base units. Combinations of base units are not included. For example, velocity can be represented by any length per time combination. However, “mph” is a common unit that cannot be parsed from basic units. Hence, “mph” is included in the list of base units while “m/s” is not. “m/s” is simply recognized by the invention.

The list of pre-programmed base units includes multiple spellings of the same units to allow the user to use both “inch” and “in” and to compensate for misspellings. For example, Excel frequently changes “MPa” to the “Mpa”. In other cases, such as “Torr” and “torr”, both spellings are encountered and both are included as base units.

Many of the SI prefixes have been included in the list of pre-programmed base units. For example, in addition to “m”, metric lengths include “km”, “cm”, and “mm”.

The number one (‘1’) can be used as a dimensionless place holder in any formula. So, for example, the units for a dimensionless parameter can be listed as ‘1’. Or, inverse units can denoted be prefacing the unit with either “1/” or even “/”. So, for example, inverse length units can be listed as “1/m” or “/m”.

Temperature is a special unit because in some cases temperature is absolute and in other cases, it is relative (a difference in temperature, not an absolute temperature). For example, if to change from degrees Fahrenheit to degrees Celsius, the formula is:

$$deg C . = ( \frac{5}{9} ) ( deg F . - 32 )$$

### However, to change the units for thermal expansion from (in/in/degF) to (m/m/degC), all that is needed is to divide by 5/9 only. 32 is not subtracted off because thermal expansion is measured in changes of temperature, not absolute temperature.

To handle this, the invention adopts the following convention. The invention distinguishes the case where temperature is a single unit in the numerator (in which case it assumes an absolute conversion) from all other cases in which case it assumes a relative conversion.

For example, in Table 5 below we change absolute temperature using the ChangeUnits function. Because all the units listed in columns B and E show only degC, degF, degK, or degR as a single base unit in the numerator, all of these interpret temperature as absolute.

TABLE 5
Changing absolute temperature.

| | A | B | C | D | E |
|---|---|---|---|---|---|
| 1 | Absolute Temperature Example | | | | |
| 2 | Value | InUnits | Equals | Output | OutUnits |
| 3 | 1 | deg C. | = | 1 | deg C. |
| 4 | 1 | deg C. | = | 33.8 | deg F. |
| 5 | 1 | deg C. | = | 274.15 | deg K |
| 6 | 1 | deg C. | = | 493.47 | deg R |
| 7 | | | | | |

In Table 6 below, we change relative temperature by putting the temperature unit in the denominator.

TABLE 6
Changing relative temperature.

| | | | |
|---|---|---|---|
| B | C | D | E |

| | |
|---|---|
| 1 | Temperature Examples |

| 2 | InUnits | Equals | Output | OutUnits |
|---|---|---|---|---|
| 3 | 1/deg C. | = | 1 | 1/deg C. |
| 4 | 1/deg C. | = | 0.555556 | 1/deg F. |
| 5 | 1/deg C. | = | 1 | 1/deg K |
| 6 | 1/deg C. | = | 0.555556 | 1/deg R |

In these examples the base units degC, degF, etc. all appear in the denominator, so they are treated as relative temperatures (e.g., differences in temperature), not absolute temperatures. Whenever temperature units are embedded in other units (such as, for example, “J/degC”) they are interpreted as a relative temperature.

Occasionally, one wants to input a temperature difference as an input quantity. This is not directly possible with the syntax convention listed above. A temperature difference of 3 degrees Fahrenheit, if input as “degF” would be converted as an absolute temperature rather than a relative temperature. In order to input relative temperatures directly in the invention, the four relative temperature units degCdiff, degKdiff, degFdiff, and degRdiff have been provided.

Table 7 below shows how to input relative temperatures directly in the invention. (As an alternative, one could also input two different input temperatures, convert each as absolute temperatures, and then subtract them to get the relative temperature. However, this is approach is cumbersome.

TABLE 7
Relative temperature units
deg C. diff, deg K diff, deg F. diff, and deg R diff.

| | B | C | D | E | F |
|---|---|---|---|---|---|
| 1 | Value | InUnits | Equals | Output | OutUnits |
| 2 | 1 | deg C. diff | = | 1 | deg C. diff |
| 3 | 1 | deg C. diff | = | 1.8 | deg F. diff |
| 4 | 1 | deg C. diff | = | 1 | deg K diff |
| 5 | 1 | deg C. diff | = | 1.8 | deg R diff |

Finally, we show in Table 8 the results of using the Grav( ) and GasConst( ) functions.

TABLE 8
The Grav and GasConst functions.

| | A | B | C |
|---|---|---|---|
| 1 | Function | arg | Output |
| 2 | Grav | — | 9.806652 |
| 3 | Gas | — | 8.31434 |

The following is a list of base units in the invention:

| | | |
|---|---|---|
| 1 A = | 1 | C/s |
| 1 acre = | 4046.86 | m\hat{ }2 |
| 1 amp = | 1 | C/s |
| 1 ampere = | 1 | C/s |
| 1 angstrom = | 1e−010 | m |
| 1 atm = | 101325 | kg/s\hat{ }2 m |
| 1 bar = | 100000 | kg/s\hat{ }2 m |
| 1 barrel = | 0.158987 | m\hat{ }3 |
| 1 boardfoot = | 0.00235974 | m\hat{ }3 |
| 1 Btu = | 1055.06 | kg m\hat{ }2/s\hat{ }2 |
| 1 btu = | 1055.06 | kg m\hat{ }2/s\hat{ }2 |
| 1 bushel = | 0.0352391 | m\hat{ }3 |
| 1 C = | 1 | C |
| 1 cal = | 4.1868 | kg m\hat{ }2/s\hat{ }2 |
| 1 carat = | 0.0002 | kg |
| 1 cc = | 1e−006 | m\hat{ }3 |
| 1 centipoise = | 0.001 | kg/s m |
| 1 centistokes = | 1e−006 | m\hat{ }2/s |
| 1 cm = | 0.01 | m |
| 1 cmWater = | 98.0638 | kg/s\hat{ }2 m |
| 1 cmHg = | 1333.22 | kg/s\hat{ }2 m |
| 1 cord = | 3.62456 | m\hat{ }3 |
| 1 coulomb = | 1 | C |
| 1 cp = | 0.001 | kg/s m |
| 1 cubit = | 0.457201 | m |
| 1 cup = | 0.000236588 | m\hat{ }3 |
| 1 D = | 9.8692e−013 | m\hat{ }2 |
| 1 darcy = | 9.8692e−013 | m\hat{ }2 |
| 1 day = | 86400 | s |
| 1 deg = | 0.0174533 | rad |
| 1 degC = | 274.15 | degK |
| 1 degCdiff = | 1 | degKdiff |
| 1 degF = | 255.928 | degK |
| 1 degFdiff = | 0.555556 | degKdiff |
| 1 degK = | 1 | degK |
| 1 degKdiff = | 1 | degKdiff |
| 1 degR = | 0.555556 | degK |
| 1 degRdiff = | 0.555556 | degKdiff |
| 1 dyne = | 1e−005 | kg m/s\hat{ }2 |
| 1 erg = | 1e−007 | kg m\hat{ }2/s\hat{ }2 |
| 1 eV = | 1.60218e−019 | kg m\hat{ }2/s\hat{ }2 |
| 1 F = | 1 | s\hat{ }2 C\hat{ }2/kg m\hat{ }2 |
| 1 farad = | 1 | s\hat{ }2 C\hat{ }2/kg m\hat{ }2 |
| 1 fathom = | 1.8288 | m |
| 1 feet = | 0.3048 | m |
| 1 fluidounce = | 2.95735e−005 | m\hat{ }3 |
| 1 fpm = | 0.00508 | m/s |
| 1 fps = | 0.3048 | m/s |
| 1 ft = | 0.3048 | m |
| 1 G = | 0.0001 | kg/s C |
| 1 g = | 0.001 | kg |
| 1 gal = | 0.00378541 | m\hat{ }3 |
| 1 gallon = | 0.00378541 | m\hat{ }3 |
| 1 gauss = | 0.0001 | kg/s C |
| 1 GJ = | 1e+009 | kg m\hat{ }2/s\hat{ }2 |
| 1 GPa = | 1e+009 | kg/s\hat{ }2 m |
| 1 Gpa = | 1e+009 | kg/s\hat{ }2 m |
| 1 Gpsi = | 6.89476e+012 | kg/s\hat{ }2 m |
| 1 grain = | 6.47989e−005 | kg |
| 1 GW = | 1e+009 | kg m\hat{ }2/s\hat{ }3 |
| 1 H = | 1 | kg m\hat{ }2/C\hat{ }2 |
| 1 h = | 3600 | s |
| 1 hectare = | 10000 | m\hat{ }2 |
| 1 henry = | 1 | kg m\hat{ }2/C\hat{ }2 |
| 1 hour = | 3600 | s |
| 1 hp = | 745.7 | kg m\hat{ }2/s\hat{ }3 |
| 1 hr = | 3600 | s |
| 1 Hz = | 6.28319 | rad/s |
| 1 hz = | 6.28319 | rad/s |
| 1 in = | 0.0254 | m |
| 1 inch = | 0.0254 | m |
| 1 inWater = | 248.84 | kg/s\hat{ }2 m |
| 1 inHg = | 3376.85 | kg/s\hat{ }2 m |
| 1 J = | 1 | kg m\hat{ }2/s\hat{ }2 |
| 1 kcal = | 4186.8 | kg m\hat{ }2/s\hat{ }2 |
| 1 kg = | 1 | kg |
| 1 kgf = | 9.80665 | kg m/s\hat{ }2 |
| 1 kip = | 4448.22 | kg m/s\hat{ }2 |
| 1 kJ = | 1000 | kg m\hat{ }2/s\hat{ }2 |
| 1 km = | 1000 | m |
| 1 kmol = | 1000 | mol |
| 1 kN = | 1000 | kg m/s\hat{ }2 |
| 1 knot = | 0.514444 | m/s |
| 1 kPa = | 1000 | kg/s\hat{ }2 m |
| 1 kpa = | 1000 | kg/s\hat{ }2 m |
| 1 kph = | 0.277778 | m/s |
| 1 KrWavelength = | 6.0578e−007 | m |
| 1 ksi = | 6.89476e+006 | kg/s\hat{ }2 m |
| 1 kW = | 1000 | kg m\hat{ }2/s\hat{ }3 |
| 1 L = | 0.001 | m\hat{ }3 |
| 1 l = | 0.001 | m\hat{ }3 |
| 1 lbf = | 4.44822 | kg m/s\hat{ }2 |
| 1 lbm = | 0.453592 | kg |
| 1 league = | 5556 | m |
| 1 lightyear = | 9.46055e+015 | m |
| 1 liter = | 0.001 | m\hat{ }3 |
| 1 m = | 1 | m |
| 1 mA = | 0.001 | C/s |
| 1 maxwell = | 1e−008 | kg m\hat{ }2/s C |
| 1 mD = | 9.8692e−016 | m\hat{ }2 |
| 1 mF = | 0.001 | s\hat{ }2 C\hat{ }2/kg m\hat{ }2 |
| 1 Mg = | 1000 | kg |
| 1 mg = | 1e−006 | kg |
| 1 mi = | 1609.34 | m |
| 1 microamp = | 1e−006 | C/s |
| 1 microfarad = | 1e−006 | s\hat{ }2 C\hat{ }2/kg m\hat{ }2 |
| 1 micron = | 1e−006 | m |
| 1 microvolt = | 1e−006 | kg m\hat{ }2/s\hat{ }2 C |
| 1 mil = | 2.54e−005 | m |
| 1 mile = | 1609.34 | m |
| 1 milliamp = | 0.001 | C/s |
| 1 millibar = | 100 | kg/s\hat{ }2 m |
| 1 millidarcy = | 9.8692e−016 | m\hat{ }2 |
| 1 millifarad = | 0.001 | s\hat{ }2 C\hat{ }2/kg m\hat{ }2 |
| 1 millipoise = | 0.0001 | kg/s m |
| 1 millivolt = | 0.001 | kg m\hat{ }2/s\hat{ }2 C |
| 1 min = | 60 | s |
| 1 MJ = | 1e+006 | kg m\hat{ }2/s\hat{ }2 |
| 1 mJ = | 0.001 | kg m\hat{ }2/s\hat{ }2 |
| 1 ml = | 1e−006 | m\hat{ }3 |
| 1 mm = | 0.001 | m |
| 1 mmHg = | 133.322 | kg/s\hat{ }2 m |
| 1 mol = | 1 | mol |
| 1 MPa = | 1e+006 | kg/s\hat{ }2 m |
| 1 Mpa = | 1e+006 | kg/s\hat{ }2 m |
| 1 mPa = | 0.001 | kg/s\hat{ }2 m |
| 1 mpa = | 0.001 | kg/s\hat{ }2 m |
| 1 mph = | 0.44704 | m/s |
| 1 Mpsi = | 6.89476e+009 | kg/s\hat{ }2 m |
| 1 ms = | 0.001 | s |
| 1 msec = | 0.001 | s |
| 1 mT = | 0.001 | kg/s C |
| 1 mV = | 0.001 | kg m\hat{ }2/s\hat{ }2 C |
| 1 MW = | 1e+006 | kg m\hat{ }2/s\hat{ }3 |
| 1 mW = | 0.001 | kg m\hat{ }2/s\hat{ }3 |
| 1 Mx = | 1e−008 | kg m\hat{ }2/s C |
| 1 N = | 1 | kg m/s\hat{ }2 |
| 1 nanofarad = | 1e−009 | s\hat{ }2 C\hat{ }2/kg m\hat{ }2 |
| 1 nm = | 1e−009 | m |
| 1 Nmile = | 5556 | m |
| 1 Oe = | 79.5775 | C/s m |
| 1 oersted = | 79.5775 | C/s m |
| 1 ohm = | 1 | kg m\hat{ }2/s C\hat{ }2 |
| 1 ozf = | 0.278014 | kg m/s\hat{ }2 |
| 1 ozm = | 0.0283495 | kg |
| 1 Pa = | 1 | kg/s\hat{ }2 m |
| 1 peck = | 0.00880977 | m\hat{ }3 |
| 1 pint = | 0.000473176 | m\hat{ }3 |
| 1 poise = | 0.1 | kg/s m |
| 1 poiseuille = | 1 | kg/s m |
| 1 psi = | 6894.76 | kg/s\hat{ }2 m |
| 1 quart = | 0.000946353 | m\hat{ }3 |
| 1 rad = | 1 | rad |
| 1 rev = | 6.28319 | rad |
| 1 reyn = | 6894.76 | kg/s m |
| 1 rpm = | 0.10472 | rad/s |
| 1 rps = | 6.28319 | rad/s |
| 1 s = | 1 | s |
| 1 sec = | 1 | s |
| 1 slug = | 14.5939 | kg |
| 1 stere = | 1 | m\hat{ }3 |
| 1 stokes = | 0.1 | m\hat{ }2/s |
| 1 stone = | 6.35029 | kg |
| 1 T = | 1 | kg/s C |
| 1 Tbs = | 1.47868e−005 | m\hat{ }3 |
| 1 tesla = | 1 | kg/s C |
| 1 ton = | 1016.05 | kg |
| 1 tonne = | 1000 | kg |
| 1 Torr = | 133.322 | kg/s\hat{ }2 m |
| 1 torr = | 133.322 | kg/s\hat{ }2 m |
| 1 tsp = | 4.92892e−006 | m\hat{ }3 |
| 1 V = | 1 | kg m\hat{ }2/s\hat{ }2 C |
| 1 volt = | 1 | kg m\hat{ }2/s\hat{ }2 C |
| 1 W = | 1 | kg m\hat{ }2/s\hat{ }3 |
| 1 Watt = | 1 | kg m\hat{ }2/s\hat{ }3 |
| 1 watt = | 1 | kg m\hat{ }2/s\hat{ }3 |
| 1 Wb = | 1 | kg m\hat{ }2/s C |
| 1 weber = | 1 | kg m\hat{ }2/s C |
| 1 week = | 604800 | s |
| 1 yard = | 0.9144 | m |
| 1 yd = | 0.9144 | m |
| 1 year = | 3.15569e+007 | s |
| 1 yr = | 3.15569e+007 | s |

While the present invention has been disclosed in the context of various aspects of presently preferred embodiments, it will be recognized that the invention may be suitably applied to other environments consistent with the claims which follow.

We claim:

1. A computer-implemented method for converting a dimensional, numerical value from one unit to another, the method comprising:
identifying an input dimensional, numerical value to convert;
expressing the units of the input, dimensional, numerical value as a string of text characters, where the text character for a space may be used to indicate the multiplication of base units within said text string;
expressing the desired output units as a string of text characters, where the text character for a space may be used to indicate the multiplication of base units within said text string;
computing and displaying the dimensional, numerical value of the input dimensional numerical value in the desired output units.

2. The method of claim 1 where more than one distinct text character may be used to indicate the multiplication of different, exponentiated base units within the text strings defining the input and output units.

3. The method of claim 2 where a mathematical formula has been programmed that yields the correct output in the desired output units for any set of consistent input units and dimensional numerical values.

4. The method of claim 1 where the desired output units are defined by a designated standard system of units.

5. The method of claim 4 where more than one distinct text character may be used to indicate the multiplication of different, exponentiated base units within the text strings defining the input units.

6. The method of claim 5 where a mathematical formula has been programmed that yields the correct output in the desired output units for any set of consistent input units and dimensional numerical values.

7. A computer-implemented system for converting a dimensional, numerical value from any input units to into an equivalent set of units defined by a designated standard system of units, the method comprising:
a memory for storing an input, dimensional, numerical value together with an input text string and an output unit text string, where the text character for a space may be used to indicate the multiplication of base units within said text strings;
a processor cooperating with the memory and with software to operate so as to convert and display the dimensional, numerical value in the designated output units.

8. The method of claim 7 where more than one distinct text character may be used to indicate the multiplication of different, exponentiated base units within the text strings defining the input and output units.

9. The computer-implemented system of claim 8 where a mathematical formula has been programmed that yields the correct output in the desired output units for any set of consistent input units and dimensional, numerical values.

10. A computer-implemented system for converting a dimensional, numerical value from one unit to another, the method comprising:
a memory for storing a dimensional, numerical value together with an input unit text string, where the text character for a space may be used to indicate the multiplication of base units within said text string;
a processor cooperating with the memory and with software to operate so as to compute and display the value of the input value in the equivalent units of the designated standard system of units.

11. The computer-implemented system of claim 10 where more than one distinct text character may be used to indicate the multiplication of different, exponentiated base units within the text strings defining the input units.

12. The computer-implemented system of claim 10 where a mathematical formula has been programmed that yields the correct output in the desired output units for any set of consistent input units and dimensional, numerical values.
